(19) United States
(12) Patent Application Publication
(10) Pub. No.: US 2005/0246062 A1
(43) Pub. Date: Nov. 3, 2005

(54) Method for controlling a machine, particularly an industrial robot

(76) Inventor: Andreas Keibel, Augsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 11/115,788

(22) Filed: Apr. 27, 2005

(30) Foreign Application Priority Data
Apr. 30, 2004 (DE) 10 2004 021 468.9

(51) Int. Cl. G06F 19/00

(52) U.S. Cl. 700/245; 700/255

(57) ABSTRACT

The invention relates to a method for controlling a machine, particularly a robot, such as a multiaxial industrial robot, in which the control takes place whilst taking account of working process-specific degrees of freedom in order to avoid kinematic fixed positions.

### FIELD OF THE INVENTION

The invention relates to a method for controlling a machine, particularly a robot, such as a multiaxial industrial robot.

### BACKGROUND OF THE INVENTION

Machines with movable parts, such as are used for infeeding a tool with respect to a workpiece or vice versa can enter kinematic fixed positions. This more particularly applies to manipulators, such as multiaxial industrial robots, which have a plurality of movable axes or axles, whereof at least two are not parallel. Such kinematic fixed positions are particular singularities, such as stretched position singularities or those in whose environment in the case of a path travel of a robot there can be increased accelerations and speeds of individual axles. The risk arises that drives in the vicinity of singular positions are unable to apply an increased acceleration and the movement of the guided tool differs in uncontrolled manner from a desired path or as a result of the singular position the control stops the movement. Other kinematic fixed positions are centre distances, increased accelerations and speeds, as well as obstacles in the working area.

Attempts have been made to deal with such kinematic fixed positions in different ways, e.g. in that hand axes on an axial plane are interpolated from a non-singular position through the singularity to another (opposite) position and the axes are controlled in Cartesian manner. Such procedures are in part associated with frequent failures and in part give rise to additional problems.

The problem of the invention is to give a method for controlling machines with movable parts, such as multiaxial industrial robots avoiding the aforementioned disadvantages.

### SUMMARY OF THE INVENTION

In the case of a method of the aforementioned type, the invention solves this problem in that the control takes place whilst taking account of working process-specific degrees of freedom in order to avoid kinematic fixed positions.

Thus, according to the invention, the movement is controlled in such a way that, whilst taking account of working process-specific degrees of freedom, the aforementioned kinematic fixed positions are avoided.

Working process-specific degrees of freedom arise in many processing or treatment processes due to existing symmetries.

According to a preferred variant, the speed profile of the movement is not modified and/or the speed of the movement is not reduced. According to the invention (only) degrees of freedom of the working process are utilized in order to retain them as such. The degrees of freedom in N-dimensional space resulting from the particular process fall back into a W-dimensional space defined by the working process in order to stay away from unfavourable positions.

Thus, on drilling, the tool holding and driving the drill can be rotated about the drill axis without the working result being changed and a rotational degree of freedom is obtained.

A workpiece moved up to a fixed belt grinder can be worked on the entire planar surface of the belt. There are two translatory degrees of freedom parallel to the belt plane.

A laser welder can (as in the example of the drill) be varied about the beam axis and optionally with respect to the distance, without there being any change to the working result. In certain cases it is additionally possible to vary within certain limits the impact angle of the beam, so that (within limits) there are in all four degrees of freedom.

The degrees of freedom obtained are generally limited to a particular displacement area and have upper and lower limits. Thus, the workpiece must not leave the grinding surface and a drill must not wind up a power cable (in that the drill is rotated several times by 360°).

Such working process-specific degrees of freedom also arise in many other working or treatment processes such as spraying or painting (with rotationally symmetrical jet), adhering, grinding, also with a rotational symmetrical grinding device, sand blasting, track-mounted welding, milling, polishing, brushing, paint removal by laser and countersinking.

An important advantage of the method according to the invention is that, without additional hardware, both the travel behaviour and the usability of machines, particularly multiaxial industrial robots, are improved. Within the scope of the working process-specific degrees of freedom it is possible to position and displace in an optimum manner the axes or axles, e.g. of an industrial robot, so as to remain remote from problematical axle positions and singular positions.

According to a preferred development of the invention an adequate spacing from kinematic fixed positions is ensured, a minimum spacing being sought. This preferably takes place in that at least one quality or power function, containing the kinematic fixed position spacing, is determined.

In a first, preferred development at least one quality function G_{LI} of the distance to the centre distances is determined. The quality function G_{LI} is a function of the axle position qᵢ, as well as the lower and upper axial or axle boundaries Iₘᵢₙ, Iₘₐₓ of axis i according to G_{LI}=f(qᵢ, Lₘᵢₙ, Lₘₐₓ). The quality function G_{LI} is a continuous and also continuously differentiatable function in the centre of the displacement area 0 and which has a maximum value precisely at the edge of the displacement area. An example for a quality function of the distance or spacing is G(qᵢ)=ax², with a=¼(Lₘₐₓ Lₘᵢₙ)² and x=(qᵢ−½(Lₘₐₓ+Lₘᵢₙ).

According to another preferred development at least one quality function Gₛᵢ of the distance from singular positions is determined and Gₛᵢ=f(qᵢ) for the singularity i. This quality function is dependent on the design of the machine, particularly the robot design. In the case of a central hand, e.g. the singularity is reached in the stretched position of the penultimate axis A5, which e.g. corresponds to the zero position of said axis. In this case the quality function value rises towards this axial position and reaches its maximum precisely at 0.

According to another preferred development of the method, at least one quality function of the spacing is determined at dynamic extreme values and in particular a quality function Gᵥᵢ of the spacing is determined at maximum speed and/or a quality function Gₖᵢ of the spacing is determined at maximum accelerations, giving:
Gᵥᵢ=f(vᵢ, Vₘₐₓ) (1)
and
G_{Ai}−f(aᵢ, Aₘₐₓ) (2)
in which vᵢ is the axial or axle speed, Vₘₐₓ the maximum axis or axle speed, aᵢ the axis or axle acceleration and Aₘₐₓ the maximum axis or axle acceleration of in each case the axis or axle i.

According to another preferred development of the invention a quality function Gₓᵢ of the distance to miscellaneous fixed positions of the machine is determined. According to the invention, as a function of the nature of the machine and the working process, random further quality functions can be defined and which in this way influence the travel behaviour of the machine or robot, e.g. for collision avoidance with G_{col}(Ψ). A G_{col}(Ψ) indicates the magnitude of the collision risk with the environment. Function input parameters can emanate from a 3D working cell model.

In a further preferred embodiment an extreme value of the quality function is determined and on the basis thereof the robot can assume an optimum position.

Further preferred developments of the invention provide for the determination of a multiple quality G_{M} from several individual quality functions or the determination of a total quality Gₜₒₜₐₗ of all the individual quality functions, in which
Gₜₒₜₐₗ(Ψ)=Σ₀^{N-1}G_{Li}(Ψ)+Σ₀^{N-1}Gᵥᵢ(Ψ)+Σ₀^{N-1}G_{Ai}(Ψ)+Σ₀^{S-1}Gₛᵢ(Ψ)+Σ₀^{x-1}Gₓᵢ(Ψ) (3)
Ψ indicates the vector of all the action directions in space, N is the number of axes or axles, S the number of singular positions, x the number of miscellaneous obligations in the location space of the machine or robot. On the basis of the support vector Ψ the quality function G_{col}(Ψ) is optimized.

According to the invention, quality function optimization preferably takes place iteratively until there is no further change to the vector Ψ. Retransformations in the joint space of the robot for the positions in the redundancy space must be calculated for the calculation of the quality. In a specific development of the invention, firstly there is a calculation of the Cartesian preset position or Cartesian desired position. This is the predetermination of the position of the tool in space through the 3 coordinates X, Y, Z (in mm) and the direction of the tool in an appropriate orientation representation and this takes place through the robot program. The robot movement control calculates in the interpolation cycle (e.g. every 4 mns) intermediate Cartesian positions between the user-preset positions in order to be able to move the robot on paths. By transformation in the axial space, for each individual intermediate position the desired positions of the drive motors (robot axes) are calculated and the control attempts to move up to these as satisfactorily as possible. By means of the total quality function, for each individual path point an optimum position within the redundancy space is determined and the aim is to implement this instead of the original function. It is also possible following optimization to check with the aid of the quality function whether the change in position in the redundancy space has led to increased axle speeds and/or accelerations. Then, optionally, a permitted transfer possibility is implemented. The optimum value of T is generally not equal to the zero vector, but is instead frequently at the edge of the redundancy space. As such a position cannot be instantaneously assumed, it cannot be excluded that the drives will be overloaded. To avoid this an interpolation takes place within the framework of the permitted accelerations and speeds along the robot path towards said optimum.

The vector Ψ of all the action directions in the new space is so set by means of iterative processes that a quality function is of an optimum nature. Thus, spatially, the robot can move within the vector space given by Ψ and its limits during the path travel without this influencing the working or treatment process. During the path travel, this space moves with the robot in space.

For optimizing the vector Ψ a quality value is calculated from a starting value by partial derivations and from this is formed the gradient which can be followed to the next local extreme value. The proximity to problematical positions is “punished” with ever larger values in the individual quality functions starting from a value Ψ₀ and then the minimum is to be sought in the total quality function as the extreme value.

### BRIEF DESCRIPTION OF THE DRAWINGS

Further advantages and features of the invention can be gathered from the claims and the following description of embodiments of the invention with reference to the attached drawings, wherein show:

FIG. 1 A multiaxial industrial robot with a singularity resulting from the stretched position on reaching the end of the working area.

FIGS. 2a-c Different permitted angular positions of the working tool when carrying out working according to FIG. 1.

FIG. 3 Avoidance of the stretched position singularity of FIG. 1 by taking account of the working process-specific degrees of freedom according to FIG. 2.

FIGS. 4a,4b Representation of the coordinate systems given to its tool in the case of a robot and the transformations between the same.

FIG. 5 A flow chart of a preferred embodiment of the inventive method.

### DETAILED DESCRIPTION OF THE DRAWINGS

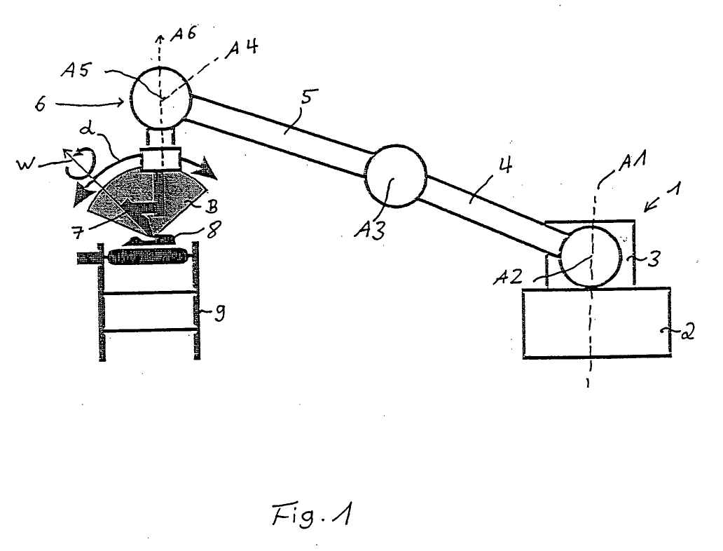

FIG. 1 shows a robot 1 with a base 2, a carrousel 3 rotatable about the A1 axis thereon, a rocker 4 articulated thereto about a horizontal axis A2, an arm 5 pivotable thereon about a horizontal axis A3, to which is in turn articulated the robot hand 6, which pivots about axes A4 to A6 a tool 7 fixed to the robot hand 6. The tool 7 is used for working a workpiece 8 held on a support 9, e.g. by soldering, applying adhesives or markings.

The grey area B indicates that the orientation or action axis W of the tool 6 can be adjusted over an angular range α (covering the surface B) without falsifying the working result. Thus, area B or angle α gives a working process-specific degree of freedom limited in the pivoting range through the value of α.

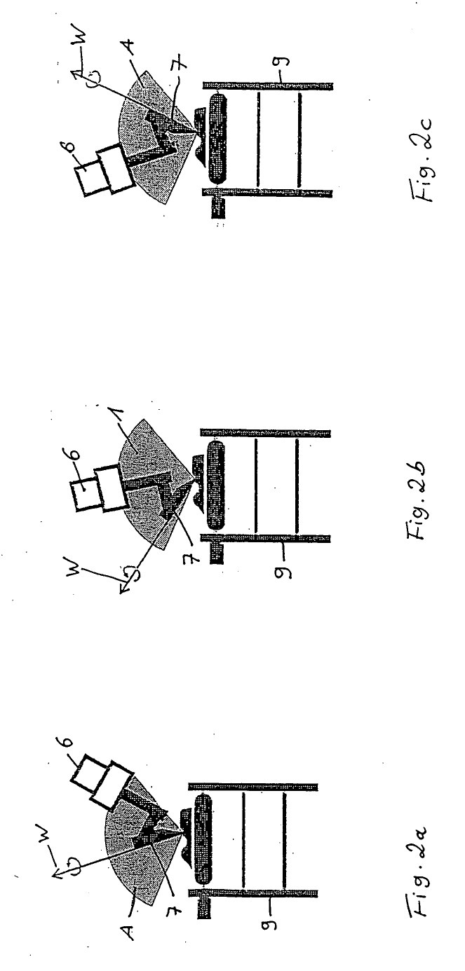

Possible positions of the tool 7 not falsifying the working result are given in FIG. 2.

It is visible from FIG. 1 that the robot is in the stretched position singularity in the area of the A3 axis interconnecting in articulated manner rocker 4 and arm 5, because in the case of an upward or downward movement of the A3 axis, whilst being accompanied by the orientation of the tool 7, there are two not readily differentiatable movement possibilities in order to e.g. move the workpiece in the direction of the base 2.

For the aforementioned reasons such singularities, such as the present stretched position singularity at the end of the working area, are not desired, because robot movements at the time of detecting such a working area breach (stretched position) are stopped and consequently the working process is interrupted.

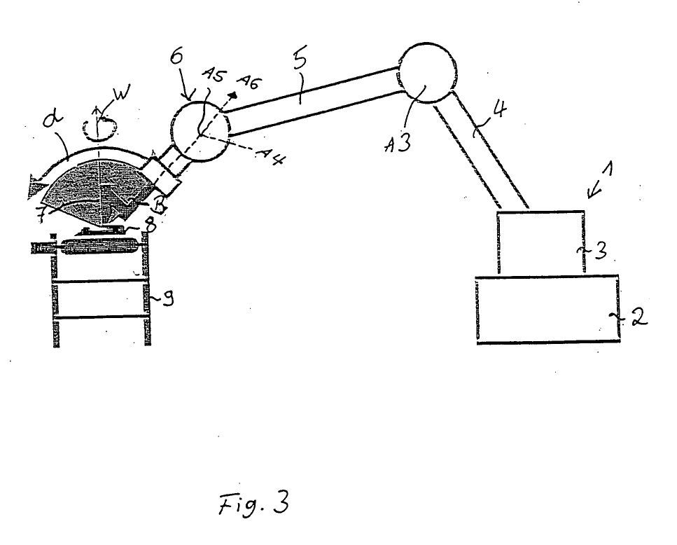

Such a situation is avoided in that the robot, according to the inventive method, is not allowed to enter the position of FIG. 1, in that according to FIG. 3 within the permitted freedom degree range B the tool 7 is oriented in such a way that the robot, with its rocker 4 and arm 5, about axis A3 can remain in a bent position without the working result being falsified.

When using the method according to the invention, in regular robot operation the robot arm is continuously brought towards the optimum position. Also in the case of manual teaching of positions by means of the manipulator an accompanying movement must be continuously possible, so that the stored target positions of a working process are already optimized. It is ensured that in the regular program sequence no compensating movements are necessary in production operation on transitions between path travel and axial position interpolations, because there has been a constant parallel optimization during the teach-in.

If e.g. a robot moves up to a position in the point-to-point mode (PTP mode), at this position the user has passed through the axial position, i.e. each individual axis angle of the robot arm. Thus, the robot position is clearly defined. This is followed by a path movement given by the 6D coordinates in space. According to the invention the robot position is set in such a way that it is of an optimum nature within the redundancy space. This repositioning in the optimum position is referred to here as “compensating movement”. FIG. 3 illustrates the difference between the two positions. When carrying out the compensating movement there is no influencing of the working process in the sense of the invention.

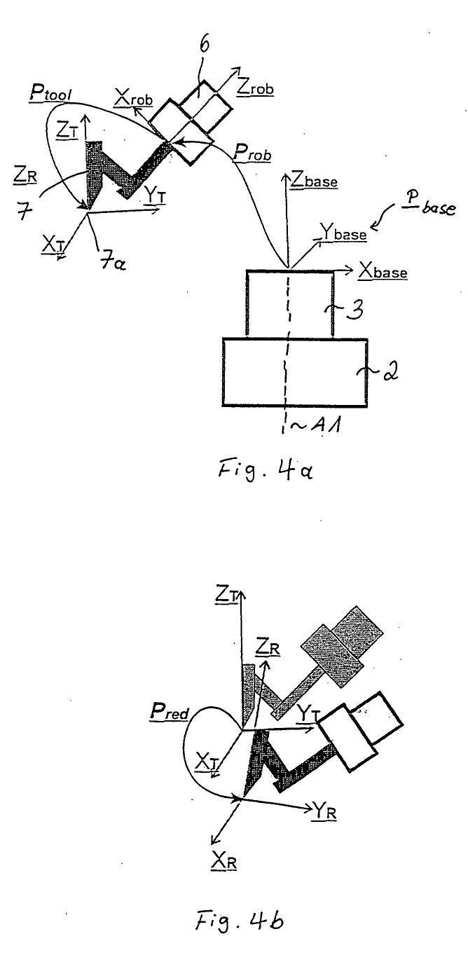

The space in which the working process-specific degrees of freedom are available for avoiding kinematic fixed positions, as implied by the definition of these degrees of freedom as working process-specific, is in each case coupled to the working or treatment process. In the case of different working processes, as explained hereinbefore, there are also different degrees of freedom and/or boundaries thereof. The working process is coupled to the tool held by the machine or robot, no matter whether the tool is fixed to the machine or robot or instead the tool is fixed, the machine or robot guiding said tool. According to the invention with the tool is allocated a tool coordinate system, which is in optimum manner oriented in such a way that the degrees of freedom obtained are favourably oriented with respect to the coordinate axes. This is illustrated in FIGS. 4a and 4b diagrammatically illustrating the relations between coordinate systems occurring in the case of a robot.

Once again the base is 2 and the carrousel 3 of a robot 1, the latter rotating about the A1 axis, which corresponds to the Z_{base} axis of the robot base coordinate system P_{base}, whose other, horizontal, Cartesian coordinate axes are X_{base}, Y_{base}. The misalignment with respect to the robot flange coordinate system X_{rob}, Y_{rob}, Z_{rob} (Y_{rob} is not shown in FIG. 4a, said coordinate axis being perpendicular to X_{rob}, Z_{rob}, i.e. perpendicular to the drawing sheet). The homogeneous transformation is designated P_{rob}. It can be mathematically described in different known ways, such as by roll-pitch-yaw, Euler, quaternions, rotation vector-rotation angle, orientation matrix, etc. (cf. e.g. ice.bachelor.fernuni-hagen.de lehre/eth009/HTML/kine1/node3.html; de.wikipe.dia.org/wiki/quaternions; www.uni-mainz.de/schoemer/publications/Diss.pdf, p 8).

The position of the point 7A of the tool 7 with Xₜ, Yₜ, Zₜ in the coordinate system of P_{rob} is designated Pₜₒₒₗ. According to the invention this position can be modified within the framework of the working process-specific free space in which the redundancies are to be defined. This working process-specific free space or the corresponding freedom degree-designating transformation is shown in FIG. 4b and designated P_{red}. Within Pₜₒₒₗ are defined the degrees of freedom of the working process. The degrees of freedom can be expressed as vector quantities Ψ=(Ψ₁, Ψ₂, . . . , Ψ_{N}) with Ψ₁ to Ψ_{N} being components or coordinates in the new free space.

As a rule all the action directions can be directly expressed in the coordinate axes of Pₜₒₒₗ. Fᵢ is a component of the vector F and gives the selection from the following possibilities, based on the coordinate axes of Pₜₒₒₗ for degree of freedom i=1 to 6:
1. rotation about X axis
2. rotation about Y axis
3. rotation about Z axis
4. displacement along X axis
5. displacement along Y axis
6. displacement along Z axis

If the action direction of the degrees of freedom cannot be directly expressed with the coordinate axes of Pₜₒₒₗ, then a transformation must be supplemented for each degree of freedom. For this can e.g. be used the representation form according to Denavit-Hartenberg (e.g. www.at-onlin.fernuni-hagen.de/lehre/eth009/HTML/kine1/node3.html), giving four values and the values of the freedom degree action directions. These so-called DH parameters are given in the form of a vector Dᵢ, in which i=0 to 3 θᵢ, dᵢ, αᵢ, aᵢ, nᵢ, with
θᵢ=rotation about Z axis [−180°. . . +180°]
dᵢ=displacement on Z axis
α₁=rotation on new X axis [−180°. . . +180°]
aᵢ=displacement on X axis
nᵢ=which of the values is the action direction of degree of freedom i [0 . . . 3].

On the basis of the values Dᵢ it is possible to model any type of degree of freedom and the action direction thereof. All the redundancy space freedom degrees are combined to matrix D composed of all the vectors Dᵢ.

The total transformation from robot foot to tool tip is consequently
Pₜₒₜₐₗ(Ψ)=P_{base}*P_{rob}*Pₜₒₒₗ*P_{red}(Ψ) (4)

On the basis of the actual robot position, it is possible with an optimization process to find and move up to this optimized value for Ψ and therefore for the redundancy transformation P_{red} (Ψ).

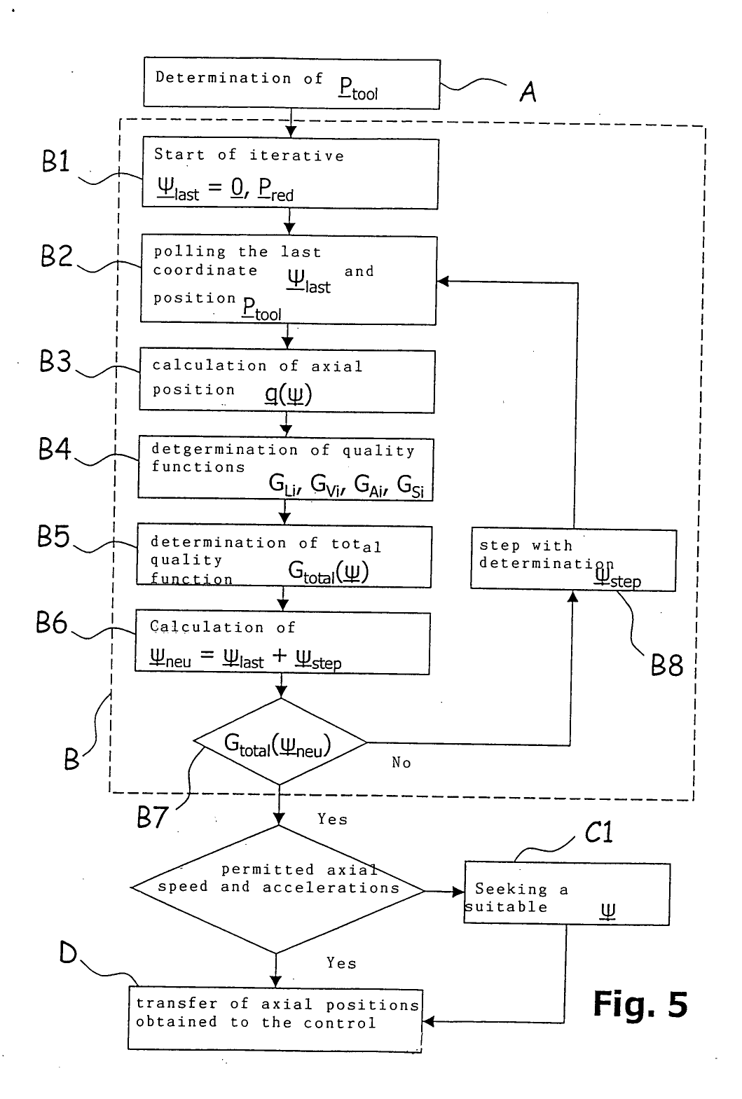

The sequence of the inventive method is represented in the flow chart of FIG. 5. Within the scope of a specific embodiment of the inventive method the following steps arise. Firstly in conjunction with the interpolation of the movement control (as explained hereinbefore) the preset cartesian positions are determined in a known manner. The result is the desired robot position in space as a homogeneous transformation Pₜₒₒₗ (step A of FIG. 5).

This is followed by the iterative optimization according to step complex B, in which the method is polled with the last coordinates Ψₗₐₛₜ in the redundancy space and the position Pₜₒₒₗ. In the first path interpolation cycle Ψₗₐₛₜ=0 and in all the following path movement interpolation cycles the value from the last interpolation cycle is used as the starting value (B1, B2).

During optimization the axial positions q(Ψ) of the robot are approached and result from the retransformation of the position P_{red} and Pₜₒₒₗ in the axial space of the robot (B3).

According to step B4 the individual quality functions are calculated during optimization iteration. From this is determined the total quality function Gₜₒₜₐₗ (Ψ) according to formula (4) (step B5). Optionally the partial derivations of this total quality are numerically determined. The result of each individual iteration step is a step in the redundancy space Ψₛₜₑₚ, which must be added to Ψₗₐₛₜ of the final cycle: Ψ_{new}=Ψₗₐₛₜ+Ψₛₜₑₚ (step B6).

In the following step B7 a check is made to establish whether the value Gₜₒₜₐₗ (Ψ_{new}) in the local extreme value is within the redundancy space or at the point on the edge of the space closest to the not reachable optimum. If this is not the case, the next iteration sequence starting with step B2 is performed (via B8).

If the value Gₜₒₜₐₗ (Ψ_{new}) in the local extreme value is within the redundancy space, in the further step C a check is made as to whether the change of position in the redundancy space leads to increased axle speeds and/or accelerations. If this is so, then a Ψ is determined located on a linear link between Ψ_{new} and Ψₗₐₛₜ, where no exceeding of limits occurs.

If the result is satisfactory, the determined axial positions of the last iteration cycle can be directly transferred to the control (step D).

The “path downwards” in the quality function can be determined according to various conventional methods, such as the gradient method, a simplified method for determining the optimum direction by investigating a certain number, e.g. eight different directions, which are in this case displaced by 45°, selecting those “pointing steepest downwards”. In this case no derivations are necessary. This is a very robust method. It is also possible to use the Gauss-Newton method or the Levenberg-Marquardt method.

Generally the method supplies a value for Ψ located at the edge of the redundancy space. It is readily possible to conceive a two-dimensional vector Ψ as the input quantity of a quality function. If the definition range of Ψ is not restricted, there is an extensive mountain landscape with a smooth surface. The peaks mark kinematic fixed positions, such as centre distances and singularities. However, the mountain landscape Ψ only has peaks if a kinematic fixed position is reached in the definition space of Ψ. This is only the case if it was possible to bring the robot into such a position by modifying Ψ.

Generally the definition space of Ψ is far away from the peaks and then the quality function will appear like the superimposing of the different slopes of the individual peaks. Only very rarely is a “trough layer” formed, in which there is an optimum Ψ as a local minimum within the definition range. It is possible to conceive a rubber layer in which the peaks are pressed from bottom to top. On the resulting extensive mountains there is only a very small cohesive area in which Ψ is defined. This area generally falls away in one direction and the permitted, optimum Ψ is correspondingly located at the edge of its definition range.

1. Method for controlling a machine, particularly a robot, such as a multiaxial industrial robot, characterized in that, whilst taking account of working process-specific degrees of freedom, control takes place in order to avoid kinematic fixed positions.

2. Method according to claim 1, wherein the control takes place in such a way that an adequate distance from kinematic fixed positions is maintained.

3. Method according to claim 1, wherein at least one quality function evaluating the spacing with respect to kinematic fixed positions is determined.

4. Method according to claim 3, wherein an extreme value of the quality function is determined.

5. Method according to claim 3, wherein at least one quality function G_{Li} of the spacing with respect to centre distances is determined.

6. Method according to claim 3, wherein at least one quality function G_{Si} of the spacing with respect to singular positions is determined.

7. Method according to claim 3, wherein at least one quality function of the spacing with respect to dynamic extreme values is determined.

8. Method according to claim 7, wherein a quality function Gᵥᵢ of the spacing with respect to maximum speed is determined.

9. Method according to claim 7, wherein a quality function G_{Ai} of the spacing with respect to maximum accelerations is determined.

10. Method according to claim 3, wherein a quality function Gₓᵢ of the spacing with respect to miscellaneous fixed positions of the machine is determined.

11. Method according to claim 1, wherein a multiple quality G_{M} of several individual qualities according to claims 5 to 10 is determined.

12. Method according to claim 1, wherein a total quality Gₜₒₜₐₗ of all the individual qualities according to claims 5 to 9 is determined.

13. Method according to claim 1, wherein an optimization of the quality takes place iteratively.

14. Method according to claim 1, wherein initially there is a calculation of the preset Cartesian position and the individual quality functions used for calculating the total quality using the last given coordinates in the redundancy space and the position of the tool are calculated and new coordinates in the redundancy space are determined.

15. Method according to claim 1, wherein after optimizing the quality function a check is made as to whether the change in the position in the redundancy space leads to increased axle speeds and/or accelerations.

16. Method according to claim 1, wherein the speed profile of the movement is not changed.

17. Method according to claim 1, wherein the speed of the movement is not reduced.
